(19) United States
(12) Patent Application Publication
(10) Pub. No.: US 2025/0213980 A1
(43) Pub. Date: Jul. 3, 2025

(54) COLLISION EVENT DETERMINATION

(71) Applicant: TENCENT TECHNOLOGY (SHENZHEN) COMPANY LIMITED, Shenzhen (CN)

(72) Inventors: Xu YANG, Shenzhen (CN); Fei XIA, Shenzhen (CN); Fei LING, Shenzhen (CN); Jun DENG, Shenzhen (CN)

(73) Assignee: TENCENT TECHNOLOGY (SHENZHEN) COMPANY LIMITED, Shenzhen, GD (CN)

(21) Appl. No.: 19/085,587

(22) Filed: Mar. 20, 2025

Related U.S. Application Data
(63) Continuation of application No. PCT/CN2024/083691, filed on Mar. 26, 2024.

(30) Foreign Application Priority Data
Mar. 30, 2023 (CN) 202310377758.6

(51) Int. Cl. A63F 13/577; A63F 13/573

(52) U.S. Cl. CPC A63F 13/577; A63F 13/573

(57) ABSTRACT

In a method for collision event determination, a first estimated trajectory that a target object is expected to follow during a next movement period is obtained. A second estimated trajectory that a collision object is expected to follow during the next movement period is obtained. A spatial positional relationship between the first estimated trajectory and the second estimated trajectory is determined to satisfy a reference collision condition. Based on the determination that the spatial positional relationship between the first estimated trajectory and the second estimated trajectory satisfies the reference collision condition, a candidate collision space that indicates a space through which the target object is not allowed to move is determined. A collision event is determined to occur between the target object and the collision object when a plurality of candidate object positions on the first estimated trajectory include a target object position in the candidate collision space.

### RELATED APPLICATIONS

The present application is a continuation of International Application No. PCT/CN2024/083691, filed on Mar. 26, 2024, which claims priority to Chinese Patent Application No. 202310377758.6, filed on Mar. 30, 2023. The entire disclosures of the prior application are hereby incorporated by reference.

### FIELD OF THE TECHNOLOGY

This disclosure relates to computers, including to a collision event determination method and apparatus, a storage medium, an electronic device, and a program product.

### BACKGROUND OF THE DISCLOSURE

In a process of rendering a game animation in real time, to improve reality of an image, an animation effect similar to that in a realistic scene is usually configured for a related event in a virtual scene. For example, when a virtual game object collides with an item object in a virtual game scene, a corresponding collision picture or collision effect is rendered.

In the related art, collision detection is usually implemented by using a discrete collision detection (DCD) method in a rendering process. In this method, object positions at different moments are usually selected to perform the collision detection, which has relatively high performance. However, due to a “discrete” nature of the discrete detection method, when a moving speed of a virtual object in a virtual scene is excessively high, or an update time of a current frame is excessively long, a collision detection object may penetrate a collision object, resulting in an unrealistic simulation phenomenon. In other words, collision determination methods have a technical problem of inaccurate detection results for the collision event.

For the aforementioned problem, no effective solution has been provided yet.

### SUMMARY

Embodiments of this disclosure include a collision event determination method and apparatus, a non-transitory storage medium, an electronic device, and a program product. The embodiments may be used, for example, to at least resolve a technical problem that the detection for a collision event by using collision detection method is inaccurate.

Technical solutions of embodiments of this disclosure may be implemented as follows.

An embodiment of this disclosure provides a collision event determination method. In the method, a first estimated trajectory that a target object is expected to follow during a next movement period is obtained. A second estimated trajectory that a collision object is expected to follow during the next movement period is obtained. A spatial positional relationship between the first estimated trajectory and the second estimated trajectory is determined to satisfy a reference collision condition. Based on the determination that the spatial positional relationship between the first estimated trajectory and the second estimated trajectory satisfies the reference collision condition, a candidate collision space that indicates a space through which the target object is not allowed to move is determined. A collision event is determined to occur between the target object and the collision object when a plurality of candidate object positions on the first estimated trajectory include a target object position in the candidate collision space.

An embodiment of this disclosure provides a collision event determination apparatus. The apparatus includes processing circuitry configured to obtain a first estimated trajectory that a target object is expected to follow during a next movement period. The processing circuitry is configured to obtain a second estimated trajectory that a collision object is expected to follow during the next movement period. The processing circuitry is configured to determine that a spatial positional relationship between the first estimated trajectory and the second estimated trajectory satisfies a reference collision condition. The processing circuitry configured to, based on determining that the spatial positional relationship between the first estimated trajectory and the second estimated trajectory satisfies the reference collision condition, determine a candidate collision space that indicates a space through which the target object is not allowed to move. The processing circuitry configured to determine that a collision event occurs between the target object and the collision object when a plurality of candidate object positions on the first estimated trajectory include a target object position in the candidate collision space.

An embodiment of this disclosure provides a non-transitory computer-readable storage medium that stores instructions, which when executed by a processor, cause the processor to perform the aforementioned collision event determination method provided in embodiments of this disclosure.

An embodiment of this disclosure provides a computer program product or a computer program, the computer program product or the computer program including a computer instruction, and the computer instruction being stored in a computer-readable storage medium. A processor of a computer device reads the computer instruction from the computer-readable storage medium, and the processor executes the computer instruction to enable the computer device to implement the collision event determination method provided in embodiments of this disclosure.

An embodiment of this disclosure provides an electronic device that includes a memory and a processor, the memory having a computer program stored therein, and the processor being configured to execute the computer program to implement the collision event determination method provided in embodiments of this disclosure.

### BRIEF DESCRIPTION OF THE DRAWINGS

FIG. 1 is a schematic diagram of a hardware environment of an alternative collision event determination method according to an embodiment of this disclosure.

FIG. 2 is a flowchart of an alternative collision event determination method according to an embodiment of this disclosure.

FIG. 3 is a schematic diagram of an alternative collision event determination method according to an embodiment of this disclosure.

FIG. 4 is a schematic diagram of another alternative collision event determination method according to an embodiment of this disclosure.

FIG. 5 is a schematic diagram of yet another alternative collision event determination method according to an embodiment of this disclosure.

FIG. 6 is a schematic diagram of yet another alternative collision event determination method according to an embodiment of this disclosure.

FIG. 7 is a schematic diagram of yet another alternative collision event determination method according to an embodiment of this disclosure.

FIG. 8 is a schematic diagram of yet another alternative collision event determination method according to an embodiment of this disclosure.

FIG. 9 is a schematic diagram of yet another alternative collision event determination method according to an embodiment of this disclosure.

FIG. 10 is a schematic diagram of yet another alternative collision event determination method according to an embodiment of this disclosure.

FIG. 11 is a schematic diagram of an alternative collision event determination apparatus according to an embodiment of this disclosure.

FIG. 12 is a schematic structural diagram of another alternative electronic device according to an embodiment of this disclosure.

### DESCRIPTION OF EMBODIMENTS

To make the objectives, technical solutions, and advantages of this disclosure clearer, the following describes this disclosure with reference to the accompanying drawings in the embodiments of this disclosure. The described embodiments are not to be considered as a limitation on this disclosure. Other embodiments are within the scope of this disclosure.

In addition, in this specification, claims, and accompanying drawings of this disclosure, the terms “first”, “second”, and the like are intended to distinguish similar objects but do not necessarily indicate a specific order or sequence. Such used data is interchangeable where appropriate so that the embodiments of this disclosure described here can be implemented in an order other than those illustrated or described here. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

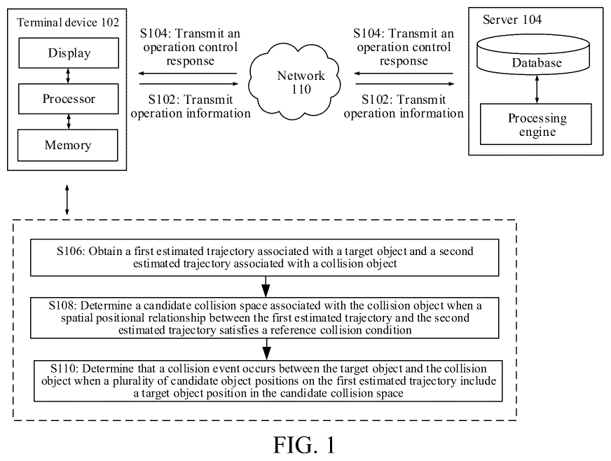

According to one aspect of embodiments of this disclosure, a collision event determination method is provided. As an alternative embodiment, the collision event determination method may be, but not limited to a collision event determination system including a terminal device 102, a server 104, and a network 110 as shown in FIG. 1. As shown in FIG. 1, the terminal device 102 is in connection and communication with the server 104 by using the network 110. The network may include, but is not limited to: a wired network and a wireless network. The wired network includes: a local area network, a metropolitan area network, and a wide area network. The wireless network includes: Bluetooth, WIFI, and other networks implementing the wireless communication. The foregoing terminal device may include but is not limited to at least one of the following: a mobile phone (such as an Android mobile phone or an iOS mobile phone), a notebook computer, a tablet computer, a palmtop computer, a mobile Internet device (MID), a PAD, a desktop computer, a smart television, an in-vehicle device, and the like. A client may be installed on the foregoing terminal device. The terminal device 102 may be provided with a client having a real-time virtual scene rendering function, such as a game client or a video play client.

The terminal device 102 is further provided with a display, a processor, and a memory. The display may be configured to display a program interface for displaying the game program, and the processor may be configured to render a virtual scene according to the obtained related processing information. The memory is configured to store various rendering data required for rendering the game scene. When receiving operation information transmitted by the terminal device 102, the server 104 may perform processing according to the operation information, and transmit a corresponding operation control response. When receiving the operation control response transmitted by the server 104 through the network 110, the terminal device 102 may update relevant scene data according to the operation control response transmitted by the server, and locally implement the rendering of the virtual scene.

The server 104 may be a single server, a server cluster formed by a plurality of servers, or a cloud server. The server includes a database and a processing engine. The processing engine is configured to process the operation information transmitted by the terminal device. The aforementioned database may be configured to store relevant information of a related virtual scene in the game client.

According to one aspect of embodiments of this disclosure, a collision event determination system may further perform the following operations:

First, Operation S102 is performed. A client in the terminal device 102 may transmit operation information, for example, control information for controlling a virtual character to move, to the server 104 through the network 110.

Subsequently, the server 104 determines a to-be-displayed virtual object element in the client according to the operation information, and performs operation S104 to transmit an operation control response to the terminal device 102 through the network 110, where the operation control response may carry virtual scene object information updated according to the operation information transmitted by the client.

Subsequently, upon receiving the operation control response transmitted by the server 104, the terminal device 102 may further perform operation S106 to operation S110.

Operation S106: Obtain a first estimated trajectory associated with a target object and a second estimated trajectory associated with a collision object, where the first estimated trajectory is an estimated trajectory that the target object is expected to following during a next movement period, and the second estimated trajectory is an estimated trajectory that the collision object is expected to following during the next movement period. In an example, a first estimated trajectory that a target object is expected to follow during a next movement period is obtained and a second estimated trajectory that a collision object is expected to follow during the next movement period is obtained.

Operation S108: Determine a candidate collision space associated with the collision object when a spatial positional relationship between the first estimated trajectory and the second estimated trajectory satisfies a reference collision condition, where the candidate collision space is configured for indicating a space through which the target object is not allowed to move. In an example, a spatial positional relationship between the first estimated trajectory and the second estimated trajectory is determined to satisfy a reference collision condition and, based on determining that the spatial positional relationship between the first estimated trajectory and the second estimated trajectory satisfies the reference collision condition, a candidate collision space that indicates a space through which the target object is not allowed to move is determined.

Operation S110: Determine that a collision event occurs between the target object and the collision object when a plurality of candidate object positions on the first estimated trajectory include a target object position in the candidate collision space. In an example, a collision event is determined to occur between the target object and the collision object when a plurality of candidate object positions on the first estimated trajectory include a target object position in the candidate collision space.

Alternatively, in this embodiment, the collision event determination method may be but is not limited to being applied to a game application scene. The game application may be a game-type terminal application (APP) that completes a given confrontation game task in the virtual scene, such as a virtual confrontational game application in a multi-player online battle arena (MOBA) application. The confrontational game task may be, but is not limited to, a game task that is completed by confrontational interaction between a virtual object in the virtual scene generated by a current player through a human-computer interaction virtual item and a virtual object controlled by another player; and the aforementioned virtual item generation method may further be applied to a terminal application of a multi-player online role-playing game (MMORPG) type. In this type of game, the current player may complete a social game task in the game in a role-playing manner and at a first viewing angle of the virtual object, for example, complete the game task together with another virtual object. The social game task herein may be but is not limited to being run in an application (such as a game APP that does not run independently) in a form of a plug-in or a mini program, or being run in an application (such as a game APP running independently) in a game engine. The types of the above game APP may include, but are not limited to, at least one of the following: two dimension (2D) game APP, three dimension (3D) game APP, virtual reality (VR) game APP, augmented reality (AR) game APP, and mixed reality (MR) game APP. The foregoing description is merely an example. This is not limited in embodiments.

In the foregoing collision event determination method, a collision possibility between the target object and the collision object is first determined according to the spatial positional relationship between the estimated trajectories of the target object and the collision object. When it is determined that the collision event may occur between the target object and the collision object according to the spatial positional relationship, the collision space associated with the collision object is determined, and whether the target object collides with the collision object is accurately determined according to a positional relationship between the target object and the collision space. In the aforementioned method, pre-detection is first performed on the collision event according to the spatial positional relationship of the trajectories, thereby avoiding precise detection performed for each possible collision, and further reducing complexity of a collision determination process. In addition, when it is determined that the collision may occur between the target object and the collision object, the collision event is precisely identified according to the positional relationship between the collision space associated with the collision object and the target object, thereby solving the technical problem that an identification result of the collision event is inaccurate, and achieving a technical effect of improving the accuracy in identifying the collision event.

The aforementioned description is merely an example. This is not limited in embodiments.

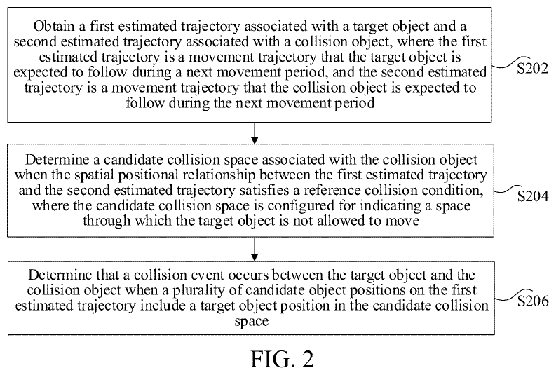

In an alternative embodiment, as shown in FIG. 2, the aforementioned collision event determination method may include the following operations.

S202: Obtain a first estimated trajectory associated with a target object and a second estimated trajectory associated with a collision object, where the first estimated trajectory is a movement trajectory that the target object is expected to follow during a next movement period, and the second estimated trajectory is a movement trajectory that the collision object is expected to follow during the next movement period. In an example, a first estimated trajectory that a target object is expected to follow during a next movement period is obtained and a second estimated trajectory that a collision object is expected to follow during the next movement period is obtained.

S204: Determine a candidate collision space associated with the collision object when the spatial positional relationship between the first estimated trajectory and the second estimated trajectory satisfies a reference collision condition, where the candidate collision space is configured for indicating a space through which the target object is not allowed to move. In an example, a spatial positional relationship between the first estimated trajectory and the second estimated trajectory is determined to satisfy a reference collision condition and, based on determining that the spatial positional relationship between the first estimated trajectory and the second estimated trajectory satisfies the reference collision condition, a candidate collision space that indicates a space through which the target object is not allowed to move is determined.

S206: Determine that a collision event occurs between the target object and the collision object when a plurality of candidate object positions on the first estimated trajectory include a target object position in the candidate collision space. In an example, a collision event is determined to occur between the target object and the collision object when a plurality of candidate object positions on the first estimated trajectory include a target object position in the candidate collision space.

In other words, when a candidate object position on the first estimated trajectory is located in the candidate collision space, the candidate object position is the target object position. In this case, it may be determined that the collision event occurs between the target object and the collision object.

In addition, the aforementioned collision event determination method may be applied but is not limited to an application that may render a virtual scene. For example, the application may include but is not limited to a game application, a video playing application, a map navigation application, or the like. In the aforementioned different types of application programs, to implement real-time rendering for the virtual scene, a collision event occurring in the virtual scene needs to be accurately identified. For example, in a game application, during a process of controlling a virtual character to move in a virtual scene, when the virtual character collides with a virtual object in the virtual scene, a collision effect needs to be rendered in real time. For another example, in a map navigation application, a virtual navigation interface corresponding to a realistic navigation scene may be rendered in the interface for a current navigation state, and a corresponding collision effect may be rendered when a collision between different virtual objects in the virtual scene is detected. In this embodiment, an application type corresponding to the collision event determination method is not limited.

In addition, corresponding to different application programs, specific execution bodies of the collision event determination method may be different. For example, in a terminal game application, the collision event determination method may be applied to a terminal, namely, the game scene is rendered in real time in the terminal; and in a cloud game application, the collision event determination method may be applied to a server, namely, the game scene is rendered in real time in the server, and an image obtained by rendering is transmitted in a video form to the terminal for displaying. In this embodiment, a specific execution body of the collision event determination method is not limited.

Specific types of the target object and the collision object in operation S202 may be determined according to a specific application scene. For example, in a game scene, the target object may be a game object element on which collision detection needs to be performed, and the collision object may be another game object element on which the collision detection needs to be performed. Specifically, the target object may be a player-controlled first virtual object in a game application, and the collision object may be a non-controllable second virtual object located in the virtual scene in the game application.

In some embodiments, the target object may further indicate some of elements included in a first virtual object in the virtual scene, and the aforementioned collision object may further indicate some of elements included in a second virtual object in the virtual scene. For example, when the virtual scene includes the player-controlled virtual object and the non-controllable virtual article, the target object may be a model object indicating a head of the virtual object, and the collision object may be a model object indicating a plane of the virtual article. Specifically, when the virtual object is a virtual character, the target object may be a sphere model indicating the head of the virtual character. When the virtual article is a desk, the collision object may be a model object indicating a desktop of the desk, namely, may be a cuboid model.

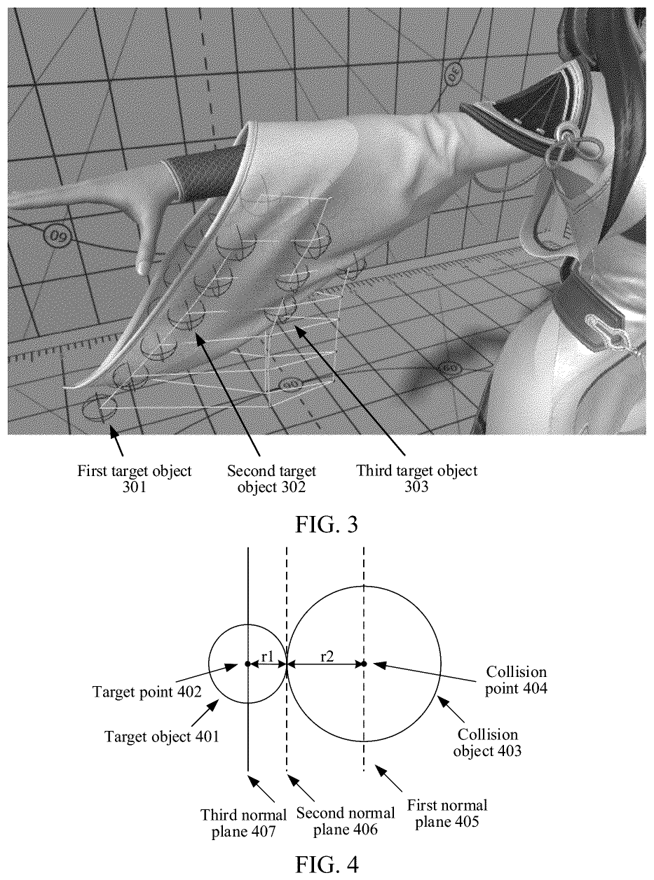

The target object and the virtual object are described in detail below with reference to FIG. 3. As shown in FIG. 3, a plurality of target objects for indicating a “virtual sleeve” of the first virtual object are illustrated, including a first target object 301 for indicating a tip portion of the “virtual sleeve”, a second target object 302 for indicating a cuff portion of the “virtual sleeve”, and a third target object 303 for indicating a hem portion of the “virtual sleeve”. As shown in FIG. 3, the plurality of target objects for indicating the “virtual sleeve” may be indicated by the sphere model, and the detection of the collision event may be performed by obtaining spherical center coordinates and a radius of each sphere model, thereby significantly improving the detection efficiency of the collision event.

In a specific embodiment, the collision detection may be performed based on position base dynamics (PBD) simulation technology. The PBD is a dynamics simulation technology widely used in real-time applications. Unlike physics-based dynamics, the PBD does not compute energy when solving elastic potential energy constraints. Since no energy is involved, there is no need to calculate the gradient of energy to derive conservative forces. As a result, computational overheads are reduced, and the operational efficiency is improved. The PBD is a position-based method. When solving deformation constraints, similar to shape matching, the position obtained after time integration is directly projected onto a constraint manifold. This process is typically completed iteratively by using Gauss-Seidel or Jacobi methods. It can be seen that the characteristic of PBD directly solving for positions makes it particularly suitable for fields where high physical accuracy is not required but real-time performance is critical.

In this embodiment, the target object may be referred to as a “bone” in the PBD simulation technology, and is configured to simulate various virtual portions of the virtual object. Compared with a vertex-based method, the bone-based PBD is more suitable for a mobile phone platform with a relatively low computing capability. In the vertex-based method, tens of thousands of particles are updated in each frame (each particle is mapped to one vertex). However, in the bone-based method, much fewer particles are updated in each frame (each particle is mapped to one bone), and the quantity of bones is typically not greater than 100. In addition, bone chains and skinning may be specified by a producer, and therefore are more controllable. This bone-based PBD method has a wide application demand in games, animations, and especially in the application scenes with high requirement on a frame rate. For example, FIG. 3 shows a plurality of target objects, i.e., a plurality of virtual bones for indicating long sleeves of a virtual character, represented as a plurality of sphere models in FIG. 3.

In addition, in operation S202, when obtaining the first estimated trajectory associated with the target object and the second estimated trajectory associated with the collision object, trajectories where the target object and the collision object are expected to follow in a next movement period after the current moment may be estimated respectively as the first estimated trajectory and the second estimated trajectory. The movement period may be an estimated duration determined for a real-time rendering scene, for example, may be 1 s or 2 s. In some embodiments, when a probability that the collision event occurs in the current real-time rendering scene is relatively low, a first duration value that is relatively large may be selected for the movement period. When the probability that the collision event occurs in the current real-time rendering scene is relatively high, a second duration value that is relatively small may be selected for the movement period.

Corresponding to different movement periods, the estimated trajectories of the target object and the collision object may differ in shape. For example, when the duration selected for the movement period is relatively long, the shape of the estimated trajectories may be determined respectively according to current movement states of the target object and the collision object. For example, when the current movement of the target object is a circular movement, the first estimated trajectory may be an arc that continues to extend along the current movement trajectory. When the current movement of the target object is a projectile motion, the first estimated trajectory may be a parabolic curve that continues to extend along the current movement trajectory. The method for determining a shape of the second estimated trajectory associated with the collision object may be similar to or the same as the method for determining the shape of the first estimated trajectory, and details are not described herein again.

In a specific method, the movement period may select the duration matching the current rendering scene. For example, when a quantity of rendering frames of the current rendering scene is 20, the movement period may be the duration of one frame of a virtual image, for example, may be 0.05 s. In other words, in this embodiment, the movement period may be configured for indicating a movement duration of each of the target object and the collision object between a current image frame and a next image frame of the virtual scene. When the movement period is the duration of one frame of image, the first estimated trajectory and the second estimated trajectory may further be simplified into line segments. For example, the estimated position of the target object or the collision object in the next image frame may be obtained separately, and a connection line between the position of the current image frame and the estimated position of the next image frame is determined as the estimated trajectory. Because a time interval between image frames is relatively short, and correspondingly, the duration corresponding to the movement period in this embodiment is relatively short, the estimated trajectory may be modeled by using the line segments, thereby improving the trajectory estimation efficiency.

Further, in operation S204, the spatial positional relationship between the first estimated trajectory and the second estimated trajectory may include one of the following: a distance between two trajectories, intersection of the two trajectories (including perpendicular intersection), and parallelism of the two trajectories. In this embodiment, a specific type of the spatial positional relationship is not limited. The reference collision condition may include but is not limited to a distance condition, an intersection relationship condition, a parallel and perpendicular relationship condition, or the like. The specific type of the reference collision condition is not limited in this embodiment.

Several alternative condition determination methods are described below. In an embodiment, the reference collision condition may be an intersection condition, namely, when the first estimated trajectory and the second estimated trajectory are intersected, it may be determined that the reference collision condition is satisfied. In another embodiment, the reference collision condition may be a distance condition, namely, when a minimum distance between the first estimated trajectory and the second estimated trajectory is less than a distance threshold, it may be determined that the reference collision condition is satisfied. In this embodiment, a specific form for determining the aforementioned condition is not limited.

In addition, when it is determined that the first estimated trajectory and the second estimated trajectory satisfy the reference collision condition, a candidate collision space associated with the target object may be determined. The candidate collision space indicates a space through which the target object is not allowed to move. Further, when the candidate collision space is determined, whether the collision event occurs may be further determined according to the positional relationship between the candidate collision space and the target object.

In some embodiments, spatial shape information or a spatial form of the candidate collision space may be determined according to a shape of the collision object. For example, when the collision object is of a quasi-spherical shape, the candidate collision space may be of a spherical form including the collision object. For another example, when the collision object is of an elongated shape, the candidate collision space may be a cylindrical form or a cuboid form including the collision object.

In another embodiment, the aforementioned candidate collision space may further be a half-space determined according to the second estimated trajectory. For example, the half-space may be defined by a curved surface established with reference to the estimated trajectory. One side of the curved surface constitutes a passable spatial area, while the other side of the curved surface including the collision object constitutes the candidate collision space where the target object is not allowed to pass. A half space determined by the curved surface is referred to as a half-space. In this embodiment, a specific form of the aforementioned candidate collision space is not limited.

In operation S204, upon determining the candidate collision space associated with the collision object, in operation S206, a plurality of candidate object positions on the first estimated trajectory are further obtained, and by comparing the plurality of candidate object positions on the first estimated trajectory with a target spatial position in the candidate collision space, if the plurality of candidate object positions include the target object position located in the candidate collision space, it is determined that a collision event occurs between the target object and the collision object.

In addition, the aforementioned candidate object positions may be selected according to an actual requirement. For example, a plurality of object positions may be selected at a predetermined time interval, or a plurality of candidate positions may be selected at a predetermined distance interval. In this embodiment, the selection manner of the aforementioned candidate object positions is not limited.

In the aforementioned collision event determination method, a probability of collision between the target object and the collision object is first determined according to the spatial positional relationship between their respective estimated trajectories. When it is determined that a collision event may occur between the target object and the collision object according to the spatial positional relationship, the collision space associated with the collision object is then determined. Subsequently, whether the target object collides with the collision object is accurately determined according to the positional relationship between the positions of the target object and the collision space. In the aforementioned method, pre-detection is first performed on the collision event according to the spatial positional relationship of the trajectories, thereby avoiding precise detection performed for each possible collision, and further reducing complexity of a collision determination process. In addition, when it is determined that the collision may occur between the target object and the collision object, the collision event is precisely identified according to the positional relationship between the collision space associated with the collision object and the target object, thereby solving the technical problem that an identification result of the collision event is inaccurate, and achieving a technical effect of improving the accuracy in identifying the collision event.

In an alternative embodiment, the operation of determining a candidate collision space associated with the collision object when the spatial positional relationship between the first estimated trajectory and the second estimated trajectory satisfies a reference collision condition includes:
S1: obtain a plurality of candidate collision positions of the collision object from the second estimated trajectory;
for each candidate collision position of the plurality of candidate collision positions,
S2: determine a candidate reference position of the candidate collision space according to the candidate collision position; and
S3: determine the candidate collision space in the candidate collision position according to the candidate reference position and spatial shape information of the candidate collision space.

In addition, in this embodiment, the candidate collision space is a spatial area obtained by following the collision object to perform real-time and synchronous movement. In other words, different candidate collision positions on the second estimated trajectory may correspond to different candidate collision spaces. The plurality of candidate collision positions may be positions on the second estimated trajectory selected according to actual requirements. For example, the plurality of candidate collision positions may be selected according to the predetermined time interval, or the plurality of candidate collision positions may be selected according to the predetermined distance interval.

In a preferable embodiment, at a same time, one candidate collision position corresponds to one candidate object position. For example, when the candidate collision positions include points A, B, and C, and the candidate object positions include points D, E, and F, the point A and the point D may be two positions corresponding to the collision object and the target object at time T0, the point B and the point E may be two positions corresponding to the collision object and the target object at time T1, and the point C and the point F may be two positions corresponding to the collision object and the target object at time T2.

The spatial shape information is configured for indicating a spatial form of the candidate collision space, for example, may include but is not limited to a spherical form, a cylindrical form, a curved form, or a half-space form, and may be preset; and alternatively, the spatial shape information may further be determined according to a specific shape of the collision object. For example, when the collision object is of a quasi-spherical shape, the spatial form of the candidate collision space is a spherical form including the collision object; and for another example, when the collision object is of an elongated shape, the spatial form of the candidate collision space may be a cylindrical form or a cubic form including the collision object. A specific form of the aforementioned candidate collision space is not limited in this embodiment.

In this embodiment, when the candidate reference positions respectively corresponding to various candidate collision positions are determined, a plurality of candidate collision spaces may be respectively determined in the plurality of candidate reference positions according to the spatial shape information, and then collision determination is performed according to the plurality of candidate collision spaces and the plurality of candidate object positions on the first trajectory.

In some embodiments, in a collision detection process, the candidate object positions and candidate collision spaces for collision detection are matched with each other. A specific matching manner may be as follows: when the candidate collision positions include points A, B, and C, and the aforementioned candidate object positions include D, E, and F, the candidate collision spaces a, b, and c are respectively determined according to the candidate collision positions A, B, and C, and then the collision detection may be performed according to the candidate collision space a and the matched candidate object position D; the collision detection is performed according to the candidate collision space b and the matched candidate object position E; and the collision detection is performed according to the candidate collision space c and the matched candidate object position F.

According to the aforementioned embodiments of this disclosure, a plurality of candidate collision positions of the collision object are obtained from the second estimated trajectory, and for each candidate collision position of the plurality of candidate collision positions, the candidate reference position of the candidate collision space is determined according to the candidate collision position; and the candidate collision spaces in the candidate collision positions are determined according to the candidate reference positions and the spatial shape information of the candidate collision spaces, whereby the collision detection is performed respectively according to a plurality of candidate collision spaces and their respective candidate object positions, to further accurately identify the spatial position where the collision event occurs.

As an alternative embodiment, the operation of determining a candidate reference position of the candidate collision space according to the candidate collision position includes:
S1: determine a position offset distance according to a first object shape of the target object and a second object shape of the collision object, where the first object shape indicates a spatial area occupied by the target object, and the second object shape indicates a spatial area occupied by the collision object; and
S2: move the candidate collision position by the position offset distance along a position offset direction to obtain the candidate reference position, where the position offset direction is a direction from the candidate collision position toward the candidate object position corresponding to the candidate collision position.

In addition, in this embodiment, the object shapes of the target object and the collision object need to be combined to accurately determine the spatial position of the collision space. The aforementioned embodiment is described in detail below with reference to FIG. 4.

As shown in FIG. 4, it is assumed that the current virtual space includes a spherical target object 401 and a spherical collision object 403 that are in a collision state, correspondingly, a spatial position of the target object 401 may be indicated by using a spatial position of a target point 402, and a spatial position of the collision object 403 may be indicated by using a spatial position of a collision point 404. The target point 402 is a spherical center of the target object 401, and a radius of the target object 401 is r1; and the collision point 404 is a spherical center of a collision object 403, and a radius of the collision object 403 is r2.

It is assumed that the spatial form of the collision space currently associated with the collision object is a half-space form, which is defined by a normal plane, one side of the normal plane is a passable space, and the other side of the normal plane is an impassable collision space. The position of the collision space may be described by using a position of the normal plane.

In some solutions, assuming that the position of the collision space is directly matched with the position of the collision point 404 configured to describe the collision object 403, a first normal plane 405 configured for describing the first collision space is obtained. In a process of comparing the position of the target point 402 with the position of the first normal plane 405, it may be determined that the target point 402 is not located in the first collision space on the right of the first normal plane 405. However, the target object 401 and the collision object 403 actually collide with each other currently. To be specific, the collision space determined directly by using the position of the collision point of the collision object cannot accurately identify the collision event.

In some other solutions, it is assumed that the position of the collision space is offset according to the shape of the collision object, namely, shifted leftwards by a distance r2 to form a second normal plane 406 describing a second collision space. In a process of comparing the position of the target point 402 with the position of the second normal plane 406, it may be determined that the target point 402 is not located in the second collision space on the right of the first normal plane 406. However, the target object 401 and the collision object 403 actually collide with each other currently. To be specific, the collision space obtained by offsetting with a volume of the collision object cannot accurately identify the collision event.

In this embodiment of this disclosure, the position of the collision space is offset according to the first object shape of the collision object 403 and the second object shape of the target object 401; and the position offset distance is a distance value of a total spatial area occupied by the first object shape and the second object shape. For example, when the first object shape and the second object shape are spheres, the position offset distance is a sum of radiuses of the two spheres. To be specific, the position is shifted leftwards by a distance of r2+r1 in FIG. 4 to form a third normal plane 407 describing a third collision space. In a process of comparing the position of the target point 402 with the position of the third normal plane 407, it may be determined that the target point 402 is located in the third collision space on the right side of the third normal plane 407. Therefore, the collision space obtained by offsetting according to the volume of the collision object and the volume of the target object may accurately identify the collision event.

According to the aforementioned embodiment of this disclosure, the position offset distance is determined according to the first object shape of the target object and the second object shape of the collision object, where the first object shape indicates a spatial area occupied by the target object, and the second object shape indicates a spatial area occupies by the collision object; and a plurality of candidate collision positions are moved respectively according to the position offset distance and the position offset direction to obtain a plurality of candidate reference positions respectively corresponding to the plurality of candidate collision positions, thereby accurately determining the spatial area in which the collision space is located, and further achieving a technical effect of accurately identifying the collision event.

As an alternative implementation, the operation of determining the candidate collision spaces in the candidate collision positions according to the candidate reference positions and the spatial shape information of the candidate collision spaces includes:
S1: obtain a reference object position of the target object and a reference collision position of the collision object when the spatial shape information indicates that the candidate collision space is a half-space area, where the reference object position is a candidate object position corresponding to the target object at a reference time, and the reference collision position is a candidate collision position corresponding to the collision object at the reference time;
S2: determine a reference spatial normal vector according to the reference object position and the reference collision position, where the position offset direction is the same as a direction of the reference spatial normal vector, and the direction of the reference spatial normal vector is a direction from the reference collision position toward the reference object position; and
S3: determine a normal plane for indicating the candidate collision space according to the reference spatial normal vector and the candidate reference position corresponding to the reference collision position, where a first side that is bounded by the normal plane is a first half-space area through which the target object is not allowed to move, a second side that is bounded by the normal plane is a second half-space area through which the target object is allowed to move, and the second half-space area is a half-space area indicated by the reference spatial normal vector.

In addition, in this embodiment, the collision space may be described in a manner of a sign distance function (SDF). The SDF is a function for describing the collision area (i.e., an impassable area), and is added to a solving process as a constraint function. The SDF is used as a metric function, and an absolute value of the SDF is a function of a distance. Positive and negative signs of the SDF represents whether a point is inside or outside the boundary.

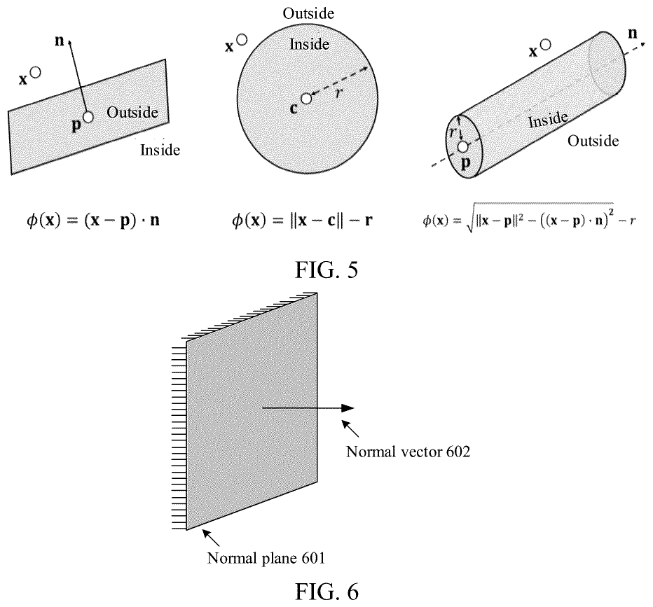

FIG. 5 shows SDF functions Ø(x) corresponding to three different spatial forms of the collision spaces, where x is a to-be-determined point. Specifically, in FIG. 5(a), the boundary is indicated by a normal plane, p is a center of the normal plane, n is a normal vector, and a direction pointing to n is outside the boundary; in FIG. 5(b), the boundary is indicated by a circle, r is a radius, c is a center of the circle, and an area outside the circle is outside the boundary; In FIG. 5(c), the boundary is indicated by a surface of a cylinder, including two bottom faces and one side face, where p is a center of the bottom face, r is a radius of the bottom face, and n is a vector direction or an axis direction of the cylinder. In FIG. 5, values of the functions Ø(x) in three different scenes may be constrained to further define a positional area corresponding to x, thereby implementing the spatial constraint.

In this embodiment, the constraint manner for the collision space may be a half-space SDF constraint manner, and the collision space of a half-space form may be described by using the normal plane. As shown in FIG. 6, the normal plane 601 divides the current virtual space into two portions, a portion to which the normal vector 602 points (i.e., the right side of the normal plane 601) is a spatial area through which the target object is allowed to move, and the left side of the normal plane 601 is the candidate collision space that is a spatial area through which the target object is not allowed to move.

In the embodiment of this disclosure, when the spatial shape information indicates that the candidate collision space is a half-space area, the reference object position of the target object and the reference collision position of the collision object are obtained; a reference spatial normal vector is determined according to the reference object position and the reference collision position, where the position offset direction is the same as a direction of the reference spatial normal vector, and the direction of the reference spatial normal vector is from the reference collision position toward the reference object position; and the normal plane for indicating the candidate collision space is determined according to the reference spatial normal vector and the candidate reference position corresponding to the reference collision position, and then a specific collision space is determined in a manner of performing half-space constraint according to a real-time position of the collision object. In the half-space constraint manner, only position of a point and the position of a vector are needed for determination, thereby avoiding describing the collision space by using a complex spatial shape, improving the efficiency in describing the collision space, and further improving the identification efficiency of the collision event detection.

In an alternative embodiment, before the operation of determining a candidate collision space associated with the collision object when the spatial positional relationship between the first estimated trajectory and the second estimated trajectory satisfies a reference collision condition, the method further includes:
S1: obtain a first object shape of the target object and a second object shape of the collision object, where the first object shape indicates a spatial area occupied by the target object, and the second object shape indicates a spatial area occupied by the collision object;
S2: determine a reference collision condition according to the first object shape and the second object shape, where the reference collision condition indicates a distance threshold for a collision event to occur between the target object and the collision object; and
S3: determine the spatial positional relationship according to a spacing distance between the first estimated trajectory and the second estimated trajectory, where the first estimated trajectory and the second estimated trajectory are respectively line segment trajectories between a current image frame and a next image frame.

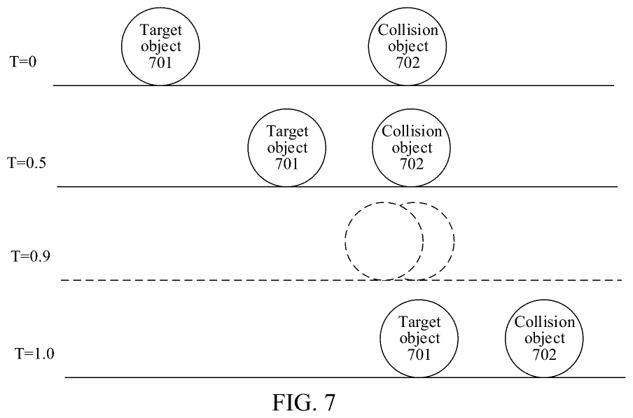

In the field of mobile games, due to requirements on the timeliness, collision processing may use a solution of discrete collision detection (DCD) and sign distance function (SDF). The DCD detects a collision state at each detection moment. As shown in FIG. 7, whether the collision occurs is detected typically at three time T=0 s, T=0.5 s, and T=1.0 s according to respective positions of the two spheres. As shown in FIG. 7, at the three detection time, i.e., t=0 s, t=0.5 s, and t=1.0 s, the target object 701 and the collision object 702 do not collide with each other. Therefore, a detection result is: the target object 701 and the collision object 702 do not collide with each other, but in fact, the two spheres collided at the time T=0.9 s.

Therefore, if two detection moments are far apart, or the movement speed of the sphere is excessively high, the collision may be missed at the detection time, thereby generating a penetration phenomenon, and further generating an unrealistic simulation phenomenon. If the missed collisions are avoided by increasing a detection density, computational overheads increase proportional to the detection density.

According to the aforementioned embodiment of this disclosure, the shapes of the target object and the collision object may be obtained first, the distance condition for performing the collision pre-detection is further determined as the reference collision condition, and the determination is performed according to the spacing distance between the two estimated trajectories and the aforementioned distance condition, thereby determining a possibility of collision occurring between the target object and the collision object.

When the distance threshold indicated by volumes of the target object and the collision object is less than the minimum distance between the two estimated trajectories, it is determined that the target object and the collision object may not collide with each other, and the subsequent collision detection operation is skipped; and when the distance threshold indicated by the volumes of the target object and the collision object is greater than or equal to the minimum distance between the two estimated trajectories, it is determined that the target object and the collision object may collide with each other, and then the subsequent collision detection operation is performed, thereby avoiding high-density and high-frequency collision detection, and improving the collision event identification efficiency.

As an alternative embodiment, when the target object and the collision object are both spheres, a sum of a first radius of the target object and a second radius of the collision object is determined as the distance threshold; and the minimum distance between the first estimated trajectory and the second estimated trajectory is determined as the spacing distance, where the first estimated trajectory is a movement trajectory of a first spherical center corresponding to the target object, and the second estimated trajectory is a movement trajectory of a second spherical center corresponding to the collision object.

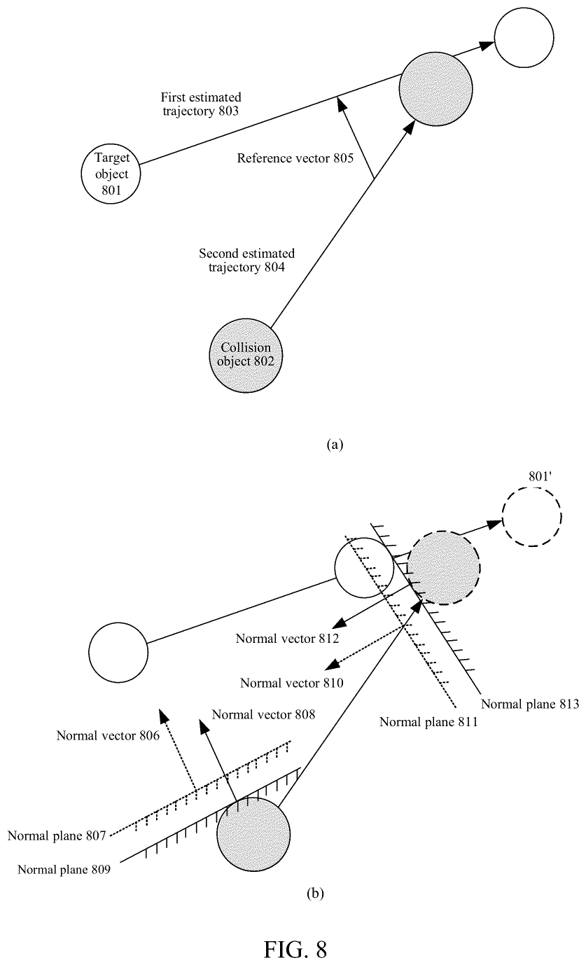

In this embodiment, when the target object and the collision object are both sphere models, the distance threshold may be determined according to a sum of radiuses of the two spheres. A method for detecting the collision between the sphere models is described below with reference to FIG. 8.

FIG. 8(a) shows a target object 801 and a first estimated trajectory 803 of the target object 801 during a movement period, and a collision object 802 and a second estimated trajectory 804 of the collision object 802 during the movement period. In this embodiment, the first estimated trajectory 803 and the second estimated trajectory 804 may be movement trajectories of a line segment form estimated for two sphere objects between two neighboring image frames.

First, a reference vector 805 corresponding to the minimum distance between the first estimated trajectory 803 and the second estimated trajectory 804 is determined.

Subsequently, a condition for creating a candidate collision space, i.e., the reference collision condition, may be determined by using the following formula:

$$minDistance < {r}_{1} + {r}_{2} + {r}_{0} \qquad ( 1 )$$

where minDistance is the minimum distance between the first estimated trajectory 803 and the second estimated trajectory 804, i.e., a modulus of the reference vector 805, and r₁ is a radius of the target object 801, r₂ is a radius of the target object 802, and r₀ is a pre-detection radius (which may be set according to actual requirements). Further, when the aforementioned reference collision condition is satisfied, the corresponding candidate collision space is generated according to the collision object 802.

Specifically, as shown in FIG. 8(b), based on the constraint half-space SDF method, a normal of the candidate collision space is calculated in the following manner:

$$normal = Normalize ( ( {x}_{1} , {y}_{1} , {z}_{1} ) - ( {x}_{2} , {y}_{2} , {z}_{2} ) ) \qquad ( 2 )$$

where (x₁, y₁, z₁) is a real-time position of the target object 801 on the first estimated trajectory 803, and (x₂, y₂, z₂) is a real-time position of the collision object 802 on the second estimated trajectory 804. According to the aforementioned formula, the direction of the normal vector of the candidate collision space is a direction from the spherical center of the collision object toward the spherical center of the target object.

Further, the position of the normal plane of the candidate collision space may be determined by using the following formula:

$${P}_{normal} = ( {x}_{2} , {y}_{2} , {z}_{2} ) + ( {r}_{1} + {r}_{2} ) * normal \qquad ( 3 )$$

According to the formula, the position of the normal plane of the candidate collision space is a position obtained by offsetting the reference distance from the spherical center position of the collision object toward the target object. The reference distance is a sum of radiuses of the target object and the collision object.

In this embodiment, the candidate object position and the candidate collision position on which collision detection is performed are respectively an end point and a start point of the trajectory. In FIG. 8(b), at the initial position of the estimated trajectory, it is determined that a normal vector indicating the candidate collision space is a normal vector 806, and the normal plane is 807. Because the determination of the positional relationship between the target object and the candidate collision space is based on the spherical center position of the target object, it is necessary to continue moving by a distance r₁ beyond the tangent of the collision object according to the radius of the target object, thereby obtaining a normal plane 809 and a normal vector 808 to serve as the candidate collision space for determining the collision event During actual rendering, an image on which collision constraint is performed may be rendered according to the normal plane 809 and the normal vector 808.

Further, as shown in FIG. 8(b), the candidate collision space may be further constructed in the aforementioned manner at the end point of the trajectory, and includes a normal vector 810 and a normal plane 811, and a normal vector 812 and a normal plane 813 after moving by the distance r₁. In this case, it is detected that the target object 801′ is located in a first half-space area of the normal plane 813 indicated by an opposite direction (i.e., out of the normal) of the normal vector 812, and it is then determined that the target object 801′ is located in the collision space, thereby determining that a collision event occurs between the current target object and the collision object.

In the aforementioned embodiment of this disclosure, when the target object and the collision object are both spheres, a first radius of the target object and a second radius of the collision object are obtained; a distance threshold that is determined according to a sum of the first radius and the second radius is taken as a reference collision condition; the minimum distance between the first estimated trajectory and the second estimated trajectory is determined as the target spacing distance, where the first estimated trajectory is a movement trajectory of a first spherical center corresponding to the target object, and the second estimated trajectory is a movement trajectory of a second spherical center corresponding to the collision object; when the target spacing distance is less than a distance threshold, it is determined that the spatial positional relationship between the first estimated trajectory and the second estimated trajectory satisfies the reference collision condition; and when the target spacing distance is greater than or equal to the distance threshold, it is determined that the spatial positional relationship between the first estimated trajectory and the second estimated trajectory does not satisfy the reference collision condition, and it is determined that no collision event occurs between the target object and the collision object during the movement period, thereby implementing accurate detection of the collision event when the target object and the collision object are both sphere models.

As an alternative embodiment, the target object is a sphere, the collision object is a capsule, the capsule is formed by two identical hemispheres and a cylinder, the two hemispheres are respectively connected to the two bottom faces of the cylinder, and the radius of each hemisphere is the same as the radius of the bottom face of the cylinder; a sum of a third radius of the target object and a fourth radius of the collision object is determined as the distance threshold, where the fourth radius is a radius of the hemisphere; and the minimum distance between the first estimated trajectory and the second estimated trajectory is determined as the spacing distance, where the first estimated trajectory is a movement trajectory of a third spherical center corresponding to the target object, the second estimated trajectory is a movement trajectory of a reference point in the capsule, and the reference point is a point on the axis of the capsule that is closest to the third spherical center.

In addition, in this embodiment, when the target object is a sphere model, and the collision object is a capsule model, a determination method for the reference collision condition in the model system may be determined in the aforementioned manner.

As an alternative embodiment, the operation of determining the minimum distance between the first estimated trajectory and the second estimated trajectory as the spacing distance includes:
S1: determine a reference vector according to a spherical center position of the third spherical center and a position of the reference point, where an indication direction of the reference vector is a direction from the position of the reference point toward the spherical center position;
S2: obtain a first projection distance of a vector corresponding to the first estimated trajectory on the reference vector, and a second projection distance of a vector corresponding to the second estimated trajectory on the reference vector; and
S3: determine the spacing distance according to the first projection distance, the second projection distance, and a third distance indicated by the reference vector. The third distance is the minimum distance between the first estimated trajectory and the second estimated trajectory, i.e., a modulus of the reference vector.

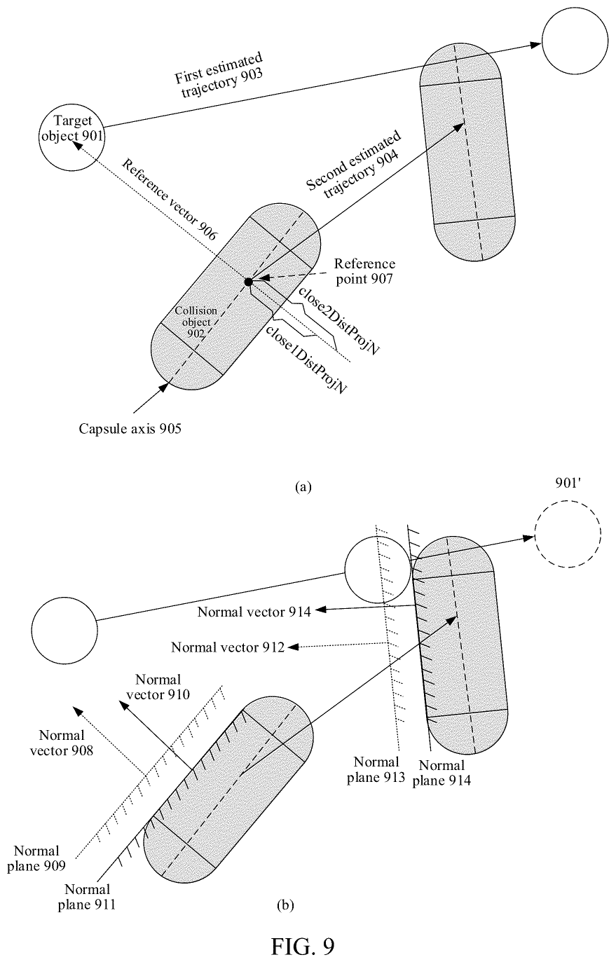

The following describes a collision detection method in a sphere-capsule model system with reference to FIG. 9. FIG. 9(a) shows a target object 901 and a first estimated trajectory 903 of the target object 901 during a movement period.

A closest point of the spherical center of the target object 901 to the axis 905 of the collision object 902 of a capsule form is determined as the reference point 907, a reference vector 906 from the reference point 907 toward the spherical center of the target object 901 is determined, and a second estimated trajectory 904 of the reference point 907 during the movement period is determined. In this embodiment, the first estimated trajectory 903 and the second estimated trajectory 904 may be movement trajectories that are of line segment forms and that are estimated between two image frames for the target object and the collision object.

Subsequently, the reference collision condition of the candidate collision space may be determined by using the following formula:

$$minDistance + close 1 DistProjN - close 2 DistProjN < {r}_{1} + {r}_{2} + {r}_{0} \qquad ( 4 )$$

minDistance is a minimum distance between the first estimated trajectory 903 and the second estimated trajectory 904, i.e., a modulus of the reference vector 906; close1DistProjN is a projection result of the first estimated trajectory 903 on the reference vector 906, close2DistProjN is a projection result of the second estimated trajectory 904 on the reference vector 906, r₀ is a pre-detection radius (which may be set according to actual requirements), r₁ is a radius of the target object 901, and r₂ is a radius of the collision object 902, i.e., the capsule (i.e., a radius of a hemisphere).

Further, when the aforementioned reference collision condition is satisfied, a corresponding collision space is generated according to the collision object 902. Specifically, as shown in FIG. 9(b),

$$normal = Normalize ( ( {x}_{1} , {y}_{1} , {z}_{1} ) - ( {x}_{2} , {y}_{2} , {z}_{2} ) ) \qquad ( 5 )$$

where (x₁, y₁, z₁) is a real-time position of the target object 901 on the first estimated trajectory 903, (x₂, y₂, z₂) is a real-time position of the reference point 907 on the collision object 902 corresponding to (x₁, y₁, z₁) on the second estimated trajectory 904. According to the above formula, the direction of the normal vector of the candidate collision space is a direction from the reference point 907 of the collision object toward the spherical center of the target object.

Further, the position of the normal plane of the candidate collision space may be determined by using the following formula:

$${P}_{normal} = ( {x}_{2} , {y}_{2} , {z}_{2} ) + ( {r}_{1} + {r}_{2} ) * normal \qquad ( 6 )$$

According to the foregoing formula, the position of the normal plane of the candidate collision space is a position obtained by offsetting the position of the reference point 907 of the collision object to the target object by the reference distance. The reference distance is a sum of a radius of the target object and a radius of the collision object. As shown in FIG. 9(b), at an initial position of the estimated trajectory, the normal vectors for indicating the candidate collision space are determined as a normal vector 908 and a normal plane 909. Because the determination of the positional relationship between the target object and the candidate collision space is based on the center position of the target object, it is necessary to move further by a distance r₁ beyond the tangent of the collision object according to the radius of the target object, thereby obtaining a normal vector 910 and a normal plane 911 for defining the candidate collision space for determining the collision event. During the actual rendering, an image on which collision constraint is performed may be rendered according to the normal plane 911 and the normal vector 910.

Further, assuming that in this embodiment, the candidate object position and the candidate collision position on which the collision detection is performed are respectively an end point and a start point of the trajectory, as shown in FIG. 9(b), the candidate collision space may be further constructed in the aforementioned method at the end point of the trajectory, and includes a normal vector 912 and a normal plane 913, and a normal vector 914 and a normal plane 915 that are obtained after moving by the reference distance. In this case, it is detected that the target object 901′ is located in a first half-space area of the normal plane 915 indicated by an opposite direction (i.e., outside the normal) of the normal vector 914, and it is then determined that the target object 901′ is located in the collision space, thereby determining that a collision event occurs between the current target object and the collision object.

In the aforementioned embodiment of this disclosure, when the target object is a sphere, and the collision object is a capsule, a sum of a third radius of the target object and a fourth radius of the collision object is obtained; a distance threshold determined according to the sum of the third radius and the fourth radius is taken as the reference collision condition; a minimum distance between the first estimated trajectory and the second estimated trajectory is determined as the target spacing distance; when the target spacing distance is less than a distance threshold, it is determined that the spatial positional relationship between the first estimated trajectory and the second estimated trajectory satisfies the reference collision condition; and when the target spacing distance is greater than or equal to the distance threshold, it is determined that the spatial positional relationship between the first estimated trajectory and the second estimated trajectory does not satisfy the reference collision condition, and it is determined that no collision event occurs between the target object and the collision object during the movement period, thereby implementing accurate detection of the collision event when the target object is a spherical model, and the collision object is a capsule model.

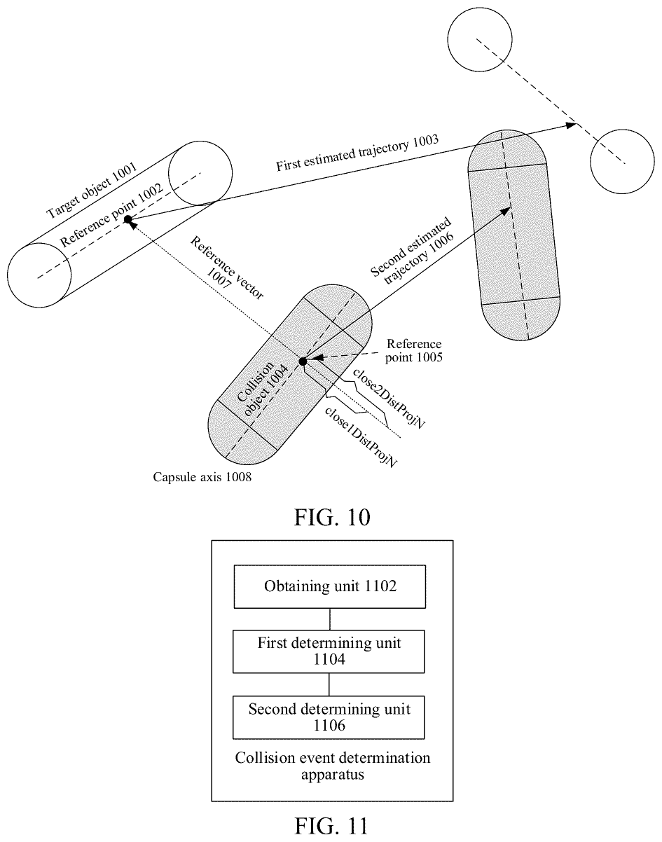

The collision detection method in another model scene is described below with reference to FIG. 10. As shown in FIG. 10, a target object 1001 is a combined model obtained by connecting two sphere models and line segments between the spheres, and a collision object 1004 is a capsule model.

Before performing collision detection on the combined model and the capsule model, two points where the distance between the axis of the target object 1001 and the axis 1008 of the collision object 1004 is minimal may be first determined. Specifically, a first reference point 1002 is determined on the axis of the target object 1001, and a second reference point 1005 is determined on the axis 1008 of the collision object 1004. A first estimated trajectory 1003 corresponding to the first reference point 1002 and a second estimated trajectory 1006 corresponding to the second reference point 1005 are respectively determined.

Subsequently, the reference collision condition of the candidate collision space corresponding to the collision object 1004 may be determined by using the following formula:

$$minDistance + close 1 DistProjN - close 2 DistProjN < {r}_{1} + {r}_{2} + {r}_{0} \qquad ( 7 )$$

minDistance is the minimum distance between the first estimated trajectory 1003 and the second estimated trajectory 1006, i.e., a modulus of a reference vector 1007, where the reference vector 1007 is a vector from the second reference point 1005 toward the first reference point 1002; close1DistProjN is a projection result of the first estimated trajectory 1003 on the reference vector 1007, close2DistProjN is a projection result of the second estimated trajectory 1006 on the reference vector 1007, r₀ is a pre-detection radius (which may be set according to actual requirements), r₁ is a radius of the target object 1001 (i.e., a radius of a sphere model in the combined model), and r₂ is a radius of the collision object 1004, i.e., a capsule (i.e., a radius of a hemisphere).

When the first estimated trajectory 1003 and the second estimated trajectory 1006 satisfy a condition, collision detection may be further performed with reference to the aforementioned collision detection method in the sphere-capsule model system. Specifically, as follows:

$$normal = Normalize ( ( {x}_{1} , {y}_{1} , {z}_{1} ) - ( {x}_{2} , {y}_{2} , {z}_{2} ) ) \qquad ( 8 )$$

where (x₁, y₁, z₁) is a real-time position of the first reference point 1002 on the first estimated trajectory 1003, (x₂, y₂, z₂) is a real-time position of a second reference point 1005 on the collision object 1004 corresponding to (x₁, y₁, z₁) on a second estimated trajectory 1006. According to the aforementioned formula, a direction of the normal vector of the candidate collision space is a direction from the second reference point 1005 of the collision object toward the first reference point 1002.

Further, the position of the normal plane of the candidate collision space may be determined by using the following formula:

$${P}_{normal} = ( {x}_{2} , {y}_{2} , {z}_{2} ) + ( {r}_{1} + {r}_{2} ) * normal \qquad ( 9 )$$

According to the above formula, the position of the normal plane of the candidate collision space is obtained by offsetting a reference distance from the position of the second reference point 1005 of the collision object toward the target object. The reference distance is a sum of a radius of the target object and a radius of the collision object capsule.

As an alternative embodiment, after the operation of determining that the collision event occurs between the target object and the collision object, the method further includes:
S1: determine an intersection point of a first estimated trajectory and a spatial boundary of a candidate collision space when the collision event occurs;
S2: determine a position corresponding to the intersection point as the target collision position; and
S3: take the target collision position as an end point position of the movement of the target object along the first estimated trajectory.

In this embodiment, when it is determined that the collision event occurs between the target object and the collision object, the position of the intersection point between the first estimated trajectory of the target object and the spatial boundary of the collision space may be determined as the target collision position, and the target object is controlled to move to the target collision position, thereby avoiding “penetration” phenomenon in an area through which the target object is not allowed to move.

According to the above embodiment of this disclosure, the intersection point between the first estimated trajectory and the spatial boundary of the candidate collision space is determined; the position corresponding to the intersection point is determined as a target collision position; and the target collision position is taken as an end point position of the movement of the target object along the first estimated trajectory, so as to determine an accurate collision position according to the collision space determined in real time, thereby improving the accuracy in detecting the collision event.

The aforementioned embodiment is described below by using specific examples.

In this embodiment, a pre-detection technology is used. By using the impenetrability of the half-space SDFf, pre-detection is performed before movement simulation of each frame, to determine whether to create a collision constraint for a single bone. The method solves a problem of penetration in the DCD+SDF without increasing the detection density. The following description is provided by using an example with respect to cases including a bone and a sphere, a bone and a capsule, and bone connecting line segments and a capsule. In this embodiment of this disclosure, the bone is configured for indicating a portion on the virtual object on which the collision detection needs to be performed, and corresponds to the target object in the aforementioned embodiment, and the bone connecting segments indicate two connected portions on the virtual object on which the collision detection needs to be performed. The sphere and the capsule are configured to indicate a virtual object in a virtual scene, and correspond to the collision object.

In a specific embodiment, a collision detection method for a bone-sphere model is provided. As shown in FIG. 8: on a 2-dimensional plane, a white sphere represents a bone, and a gray sphere represents a collision object. First, a movement trajectory line segment of the bone in the current frame is calculated, and then a movement trajectory line segment of the sphere is calculated. Subsequently, the minimum distance minDistance between two line segments, i.e., a reference vector 805, is obtained. A radius r1 of the bone and a radius r2 of the sphere are known, and a pre-detection radius r0 is added. When minDistance<r1+r2+r0, the reference collision condition is satisfied. Constraint half-space SDF normal=Normalize (bone coordinates-spherical coordinates), and position=spherical center+(bone radius+spherical radius)*SDF normal. As shown in FIG. 8(b), a position (a dashed white sphere) of the bone during the detection has no overlapping area with the spherical position, and the collision cannot be detected in some detection solutions. However, in this embodiment, as the pre-detection-created candidate collision space moves with the sphere, the movement of the bone is ultimately constrained correctly in a passable area.

In another specific embodiment, when determining collision between the bone and the capsule, as shown in FIG. 9, the closest reference point of the bone to the axis of the capsule and a reference vector 906 from the reference point to the bone are calculated first, and then movement trajectory line segments of the bone and the reference point on the axis of the capsule are projected onto the reference vector 906, to obtain respective projection lengths close1DistProjN and close2DistProjN. The bone radius r1, the capsule radius r2, and the pre-detection radius r0 are known. When minDistance+close1DistProjN−close2DistProjN<r1+r2+r0, the reference collision condition is satisfied. Normal=Normalize (bone coordinate-capsule axis reference point), and position=capsule axis reference point+(bone radius+capsule radius)*SDF normal. As shown in FIG. 9(b), the constraint on the bone moves and rotates with the capsule, and constrains the movement of the bone to be in the passable area.

In yet another specific embodiment, when determining the bone connecting line segments and the capsule, the method is similar to that used for determining the bone and the capsule. The difference lies in that, at the start frame, a vector between the reference point of the bone connecting line segment and the reference point of the capsule axis is used as a reference vector, and the projection lengths of the movement trajectory line segments of the two reference points on the reference vector are determined. After the reference collision condition is satisfied, half-space SDF normal=Normalize (reference point of bone connecting line segment−reference point of capsule axis), and position=reference point of capsule axis+(bone radius+capsule radius)*SDF normal. When an edge constraint is solved, both the two reference points need to be limited outside the candidate collision space.

According to the aforementioned embodiment of this disclosure, a discrete collision detection solution is provided. Before performing collision detection, whether to create a half-space SDF constraint for the current simulation bone in the current simulation frame is determined according to the distance relationships between the movement start point and end point positions and the movement linear trajectory of the simulation bone, and between the start point and end point positions and the movement linear trajectory of the collision object. Due to a position constraint characteristic of the half-space SDF constraint, even if the movement distance of the simulation bone is excessively large, a phenomenon of penetrating the collision object is avoided. Therefore, the problem of penetration in the DCD+SDF solution is solved without increasing the detection density, computation overheads are reduced, and the detection efficiency is improved.

In addition, for ease of description, the foregoing method embodiments are described as a series of action combinations. However, persons skilled in the art know that this disclosure is not limited to the described order of the actions because some operations may be performed in another order or performed at the same time according to this disclosure. In addition, a person skilled in the art is further to learn that the embodiments described in this specification are all exemplary embodiments, and the involved actions and modules are not necessarily required to this disclosure.

According to another aspect of embodiments of this disclosure, a collision event determination apparatus for implementing the collision event determination method is further provided. As shown in FIG. 11, the apparatus includes:

an obtaining unit 1102, configured to obtain a first estimated trajectory associated with a target object and a second estimated trajectory associated with a collision object, where the first estimated trajectory is a movement trajectory that the target object is expected to follow during a next movement period, and the second estimated trajectory is a movement trajectory that the collision object is expected to follow during the next movement period;

a first determining unit 1104, configured to determine a candidate collision space associated with the collision object when a spatial positional relationship between the first estimated trajectory and the second estimated trajectory satisfies a reference collision condition, where the candidate collision space is configured for indicating a space through which the target object is not allowed to move; and

a second determining unit 1106, configured to determine that a collision event occurs between the target object and the collision object when a plurality of candidate object positions on the first estimated trajectory include a target object position in the candidate collision space.

Alternatively, in this embodiment, for embodiments to be implemented by the foregoing unit modules, refer to the foregoing method embodiments, and details are not described herein again.

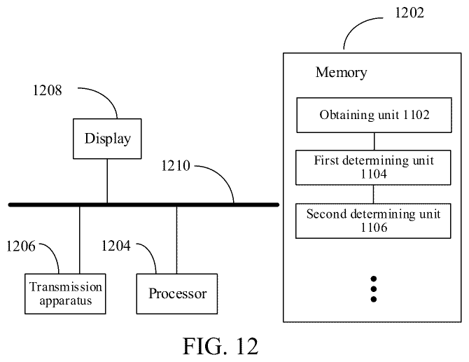

According to another aspect of embodiments of this disclosure, an electronic device for implementing the aforementioned collision event determination method is further provided. The electronic device may be a terminal device or a server as shown in FIG. 12. In this embodiment, an example in which the electronic device is the terminal device is used for description. As shown in FIG. 12, the electronic device includes a memory 1202 and a processor 1204. The memory 1202 has a computer program stored therein, and the processor 1204 is configured to perform operations in any of the foregoing method embodiments by using the computer program.

Alternatively, in this embodiment, the electronic device may be located in at least one network device of a plurality of network devices in a computer network.

Alternatively, in this embodiment, the processor may be configured to execute the computer program to perform the following operations:
S1: obtain a first estimated trajectory associated with a target object and a second estimated trajectory associated with a collision object, where the first estimated trajectory is a movement trajectory that the target object is expected to follow during a next movement period, and the second estimated trajectory is a movement trajectory that the collision object is expected to follow during the next movement period.
S2: determine a candidate collision space associated with the collision object when a spatial positional relationship between the first estimated trajectory and the second estimated trajectory satisfies a reference collision condition, where the candidate collision space is configured for indicating a space through which the target object is not allowed to move; and
S3: determine that a collision event occurs between the target object and the collision object when a plurality of candidate object positions on the first estimated trajectory include a target object position in the candidate collision space.

In some embodiments, a person of ordinary skill in the related art may understand that, a structure shown in FIG. 12 is only schematic. The electronic device may alternatively be a terminal device such as an in-vehicle terminal, a smartphone (such as an Android mobile phone or an iOS mobile phone), a tablet computer, a palmtop computer, a mobile Internet device (MID), or a portable Android device (PAD). The structure of the foregoing electronic device is not limited in FIG. 12. For example, the electronic device may further include more or fewer components (for example, a network interface) than those shown in FIG. 12, or has a configuration different from that shown in FIG. 12.

The memory 1202 may be configured to store a software program and a module, such as a program instruction/module corresponding to the collision event determination method and apparatus in embodiments of this disclosure, and the processor 1204 performs various functional applications and data processing by running the software programs and the module stored in the memory 1202, namely, implements the foregoing collision event determination method. The memory 1202 may include a high-speed random memory, and may further include a non-volatile memory, for example, one or more magnetic storage apparatuses, a flash memory, or another nonvolatile solid-state memory. In some embodiments, the memory 1202 may further include memories remotely disposed relative to the processor 1204, and the remote memories may be connected to a terminal through a network. Examples of the network include, but are not limited to, the Internet, an Intranet, a local area network, a mobile communication network, and a combination thereof. The memory 1202 may be specifically, but is not limited to, configured to store files such as a target logic file. As an example, as shown in FIG. 12, the memory 1202 may include, but is not limited to, an obtaining unit 1102, a first determining unit 1104, and a second determining unit 1106 in the foregoing collision event determination apparatus. In addition, the memory may include, but is not limited to another module unit in the foregoing collision event determination apparatus. Details are not described again in this example.

In some embodiments, a transmission apparatus 1206 is configured to receive or transmit data via a network. Specific examples of the network include a wired network and a wireless network. In an example, the transmission device 1206 includes a network interface controller (NIC). The NIC may be connected to another network device and a router by using a network cable, so as to communicate with the Internet or a local area network. In an example, the transmission device 1206 is a radio frequency (RF) module, which communicates with the Internet in a wireless manner.

In addition, the electronic device further includes: a display 1208, and a connection bus 1210 configured to connect various module components in the electronic device.

In other embodiments, the foregoing terminal device or server may be a node in a distributed system. The distributed system may be a block-chain system, the block-chain system may be a distributed system formed by connecting a plurality of nodes through network communication. A peer to peer (P2P) network may be formed between the nodes. Any form of a computing device, such as the server, the terminal, and another electronic device, may become a node in the block-chain system by joining the peer-to-peer network.

According to an aspect of this disclosure, a computer program product is provided. The computer program product includes a computer program/instruction. The computer program/instruction include a program code for implementing the method shown in the flowchart. In such an embodiment, the computer program may be downloaded and installed from a network through the communication part, and/or installed from the removable medium. When executed by a central processing unit, the computer program executes functions provided in embodiments of this disclosure.

The sequence numbers of the foregoing embodiments of this disclosure are merely for description purpose but do not imply the preference among the embodiments.

According to an aspect of this disclosure, a computer-readable storage medium is provided. A processor of a computer device reads a computer instruction from the computer-readable storage medium. The processor executes the computer instruction, to enable the computer device to implement the collision event determination method.

Alternatively, in this embodiment, the computer-readable storage medium may be configured to store a computer program configured for implementing the following operations:
S1: obtain a first estimated trajectory associated with a target object and a second estimated trajectory associated with a collision object, where the first estimated trajectory is a movement trajectory that the target object is expected to follow during a next movement period, and the second estimated trajectory is a movement trajectory that the collision object is expected to follow during the next movement period;
S2: determine a candidate collision space associated with the collision object when a spatial positional relationship between the first estimated trajectory and the second estimated trajectory satisfies a reference collision condition, where the candidate collision space is configured for indicating a space through which the target object is not allowed to move; and
S3: determine that a collision event occurs between the target object and the collision object when a plurality of candidate object positions on the first estimated trajectory include a target object position in the candidate collision space.

Alternatively, in this embodiment, a person of ordinary skill in the art may understand that, all or some operations in the methods of the foregoing embodiments may be performed by a program instructing hardware of the terminal device. The program may be stored in a computer-readable storage medium. The storage medium may include: a flash drive, a Read-Only Memory (ROM), a Random Access Memory (RAM), a magnetic disk, an optical disc, and the like.

When the integrated unit in the foregoing embodiments is implemented in a form of a software functional unit and sold or used as an independent product, the integrated unit may be stored in the foregoing computer-readable storage medium. Based on such an understanding, the technical solutions of this disclosure essentially, or a part contributing to the related art, or all or a part of the technical solution may be implemented in a form of a software product. The computer software product is stored in a storage medium and includes several instructions for instructing one or more computer devices (which may be a personal computer (PC), a server, a network device or the like) to perform all or some operations of the methods in the embodiments of this disclosure.

In the foregoing embodiments of this disclosure, the descriptions of the embodiments have respective focuses. For a part that is not described in detail in an embodiment, refer to related descriptions in other embodiments.

In the several embodiments provided in this disclosure, it is to be understood that, the disclosed client may be implemented in another manner. The foregoing described apparatus embodiments are merely examples. For example, the unit division is merely logical function division and there may be other division manners in other implementations. For example, multiple units or components may be combined or integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The units described as separate parts may or may not be physically separated, and components displayed as units may or may not be physical units, namely, may be located in one position, or may be distributed on a plurality of network units. Some or all of the units may be selected according to actual needs to achieve the objectives of the solutions of the embodiments.

In addition, functional units in the embodiments of this disclosure may be integrated into one processing unit, or each of the units may be physically separated, or two or more units may be integrated into one unit. The integrated unit may be implemented in the form of hardware, or may be implemented in a form of a software functional unit.

The foregoing descriptions are merely exemplary embodiments of this disclosure. A person of ordinary skill in the art may further make several improvements and modifications without departing from the principle of this disclosure, and the improvements and modifications fall within the protection scope of this disclosure.

What is claimed is:

1. A collision event determination method, comprising:
obtaining a first estimated trajectory that a target object is expected to follow during a next movement period;
obtaining a second estimated trajectory that a collision object is expected to follow during the next movement period;
determining that a spatial positional relationship between the first estimated trajectory and the second estimated trajectory satisfies a reference collision condition;
based on the spatial positional relationship between the first estimated trajectory and the second estimated trajectory being determined to satisfy the reference collision condition, determining a candidate collision space that indicates a space through which the target object is not allowed to move; and
determining that a collision event occurs between the target object and the collision object when a plurality of candidate object positions on the first estimated trajectory include a target object position in the candidate collision space.

2. The method according to claim 1, wherein the determining the candidate collision space comprises:
obtaining a plurality of candidate collision positions of the collision object from the second estimated trajectory; and
for each candidate collision position of the plurality of candidate collision positions, determining a candidate reference position of the candidate collision space according to the candidate collision position; and
determining the candidate collision space for the candidate collision position according to both the candidate reference position and spatial shape information of the candidate collision space.

3. The method according to claim 2, wherein the determining the candidate reference position comprises:
determining a position offset distance according to a first object shape of the target object and a second object shape of the collision object, the first object shape indicating a spatial area occupied by the target object, and the second object shape indicating a spatial area occupied by the collision object; and
obtaining the candidate reference position based on moving the candidate collision position by the position offset distance along a position offset direction from the candidate collision position toward the candidate object position corresponding to the candidate collision position.

4. The method according to claim 3, wherein the determining the candidate collision space for the candidate collision position comprises:
obtaining a reference object position of the target object and a reference collision position of the collision object when the spatial shape information indicates that the candidate collision space is a half-space area, the reference object position comprising a candidate object position corresponding to the target object at a reference time, and the reference collision position comprising a candidate collision position corresponding to the collision object at the reference time;
determining a reference spatial normal vector according to the reference object position and the reference collision position, the position offset direction comprising a direction of the reference spatial normal vector, and the direction of the reference spatial normal vector comprising a direction from the reference collision position toward the reference object position; and
determining a normal plane for indicating the candidate collision space according to the reference spatial normal vector and the candidate reference position corresponding to the reference collision position, where a first side of the candidate collision space is bounded by the normal plane comprising a first half-space area through which the target object is not allowed to move, a second side of the candidate collision space is bounded by the normal plane comprising a second half-space area through which the target object is allowed to move, and the second half-space area comprising a half-space area indicated by the reference spatial normal vector.

5. The method according to claim 1, wherein the determining that the spatial positional relationship between the first estimated trajectory and the second estimated trajectory satisfies the reference collision condition comprises:
obtaining a first object shape of the target object and a second object shape of the collision object, the first object shape indicating a spatial area occupied by the target object, and the second object shape indicating a spatial area occupied by the collision object;
determining the reference collision condition according to the first object shape and the second object shape, the reference collision condition indicating a distance threshold for the collision event to occur between the target object and the collision object; and
determining the spatial positional relationship according to a spacing distance between the first estimated trajectory and the second estimated trajectory, the first estimated trajectory and the second estimated trajectory comprising respective line segment trajectories between a current image frame and a next image frame.

6. The method according to claim 5, wherein the target object and the collision object are both spheres, a sum of a first radius of the target object and a second radius of the collision object is determined as the distance threshold; and a minimum distance between the first estimated trajectory and the second estimated trajectory is determined as the spacing distance, the first estimated trajectory comprising a movement trajectory of a first spherical center corresponding to the target object, and the second estimated trajectory comprising a movement trajectory of a second spherical center corresponding to the collision object.

7. The method according to claim 5, wherein the target object is a sphere, the collision object is a capsule, the capsule is formed by two identical hemispheres and a cylinder, the two hemispheres are respectively connected to two bottom faces of the cylinder, and a radius of each hemisphere is the same as a radius of the bottom face of the cylinder;
a sum of a third radius of the target object and a fourth radius of the collision object is determined as the distance threshold, wherein the fourth radius is a radius of the hemisphere; and
a minimum distance between the first estimated trajectory and the second estimated trajectory is determined as the spacing distance, wherein the first estimated trajectory is a movement trajectory of a third spherical center corresponding to the target object, the second estimated trajectory is a movement trajectory of a reference point in the capsule, and the reference point is a point on an axis of the capsule that is closest to the third spherical center.

8. The method according to claim 6, comprising:
determining that the spatial positional relationship between the first estimated trajectory and the second estimated trajectory satisfies the reference collision condition when the spacing distance is less than the distance threshold; and
determining that the spatial positional relationship between the first estimated trajectory and the second estimated trajectory does not satisfy the reference collision condition when the spacing distance is greater than or equal to the distance threshold, and determining that no collision event occurs between the target object and the collision object during the movement period.

9. The method according to claim 7, wherein the determining the minimum distance between the first estimated trajectory and the second estimated trajectory as the spacing distance comprises:
determining a reference vector according to a spherical center position of the third spherical center and a position of the reference point, an indication direction of the reference vector comprising a direction from the position of the reference point toward the spherical center position;
obtaining a first projection distance of a vector corresponding to the first estimated trajectory on the reference vector, and a second projection distance of a vector corresponding to the second estimated trajectory on the reference vector; and
determining the spacing distance according to the first projection distance, the second projection distance, and a third distance indicated by the reference vector.

10. The method according to claim 1, comprising:
determining an intersection point of the first estimated trajectory and a spatial boundary of the candidate collision space;
determining a position corresponding to the intersection point as a target collision position; and
taking the target collision position as an end point position of the movement of the target object along the first estimated trajectory.

11. A collision event determination apparatus comprising:
processing circuitry configured to:
obtain a first estimated trajectory that a target object is expected to follow during a next movement period;
obtain a second estimated trajectory that a collision object is expected to follow during the next movement period;
determine that a spatial positional relationship between the first estimated trajectory and the second estimated trajectory satisfies a reference collision condition;
based on the spatial positional relationship between the first estimated trajectory and the second estimated trajectory satisfies the reference collision condition, determine a candidate collision space that indicates a space through which the target object is not allowed to move; and
determine that a collision event occurs between the target object and the collision object when a plurality of candidate object positions on the first estimated trajectory include a target object position in the candidate collision space.

12. The apparatus according to claim 11, wherein the determine the candidate collision space comprises:
obtain a plurality of candidate collision positions of the collision object from the second estimated trajectory; and
for each candidate collision position of the plurality of candidate collision positions,
determine a candidate reference position of the candidate collision space according to the candidate collision position; and
determine the candidate collision space for the candidate collision position according to both the candidate reference position and spatial shape information of the candidate collision space.

13. The apparatus according to claim 12, wherein the determine the candidate reference position comprises:
determine a position offset distance according to a first object shape of the target object and a second object shape of the collision object, the first object shape indicating a spatial area occupied by the target object, and the second object shape indicating a spatial area occupied by the collision object; and
obtain the candidate reference position based on moving the candidate collision position by the position offset distance along a position offset direction from the candidate collision position toward the candidate object position corresponding to the candidate collision position.

14. The apparatus according to claim 13, wherein the determine the candidate collision space for the candidate collision position comprises:
obtain a reference object position of the target object and a reference collision position of the collision object when the spatial shape information indicates that the candidate collision space is a half-space area, the reference object position comprising a candidate object position corresponding to the target object at a reference time, and the reference collision position comprising a candidate collision position corresponding to the collision object at the reference time;
determine a reference spatial normal vector according to the reference object position and the reference collision position, the position offset direction comprising a direction of the reference spatial normal vector, and the direction of the reference spatial normal vector comprising a direction from the reference collision position toward the reference object position; and
determine a normal plane for indicating the candidate collision space according to the reference spatial normal vector and the candidate reference position corresponding to the reference collision position, where a first side of the candidate collision space is bounded by the normal plane comprising a first half-space area through which the target object is not allowed to move, a second side of the candidate collision space is bounded by the normal plane comprising a second half-space area through which the target object is allowed to move, and the second half-space area comprising a half-space area indicated by the reference spatial normal.

15. The apparatus according to claim 11, wherein the determine that the spatial positional relationship between the first estimated trajectory and the second estimated trajectory satisfies the reference collision condition comprises:
obtain a first object shape of the target object and a second object shape of the collision object, the first object shape indicating a spatial area occupied by the target object, and the second object shape indicating a spatial area occupied by the collision object;
determine the reference collision condition according to the first object shape and the second object shape, the reference collision condition indicating a distance threshold for the collision event to occur between the target object and the collision object; and
determine the spatial positional relationship according to a spacing distance between the first estimated trajectory and the second estimated trajectory, the first estimated trajectory and the second estimated trajectory comprising respective line segment trajectories between a current image frame and a next image.

16. The apparatus according to claim 15, wherein
the target object and the collision object are both spheres, a sum of a first radius of the target object and a second radius of the collision object is determined as the distance threshold; and
a minimum distance between the first estimated trajectory and the second estimated trajectory is determined as the spacing distance, the first estimated trajectory comprising a movement trajectory of a first spherical center corresponding to the target object, and the second estimated trajectory comprising a movement trajectory of a second spherical center corresponding to the collision object.

17. The apparatus according to claim 15, wherein the target object is a sphere, the collision object is a capsule, the capsule is formed by two identical hemispheres and a cylinder, the two hemispheres are respectively connected to two bottom faces of the cylinder, and a radius of each hemisphere is the same as a radius of the bottom face of the cylinder;
a sum of a third radius of the target object and a fourth radius of the collision object is determined as the distance threshold, wherein the fourth radius is a radius of the hemisphere; and
a minimum distance between the first estimated trajectory and the second estimated trajectory is determined as the spacing distance, wherein the first estimated trajectory is a movement trajectory of a third spherical center corresponding to the target object, the second estimated trajectory is a movement trajectory of a reference point in the capsule, and the reference point is a point on an axis of the capsule that is closest to the third spherical center.

18. A non-transitory computer-readable storage medium, storing instructions which when executed by a processor cause the processor to perform:
obtaining a first estimated trajectory that a target object is expected to follow during a next movement period;
obtaining a second estimated trajectory that a collision object is expected to follow during the next movement period;
determining that a spatial positional relationship between the first estimated trajectory and the second estimated trajectory satisfies a reference collision condition;
based on the spatial positional relationship between the first estimated trajectory and the second estimated trajectory being determined to satisfy the reference collision condition, determining a candidate collision space that indicates a space through which the target object is not allowed to move; and
determining that a collision event occurs between the target object and the collision object when a plurality of candidate object positions on the first estimated trajectory include a target object position in the candidate collision space.

19. The non-transitory computer-readable storage medium of claim 18, wherein the determining the candidate collision space comprises:
obtaining a plurality of candidate collision positions of the collision object from the second estimated trajectory; and
for each candidate collision position of the plurality of candidate collision positions,
determining a candidate reference position of the candidate collision space according to the candidate collision position; and
determining the candidate collision space for the candidate collision position according to both the candidate reference position and spatial shape information of the candidate collision space.

20. The non-transitory computer-readable storage medium of claim 19, wherein the determining the candidate reference position comprises:
determining a position offset distance according to a first object shape of the target object and a second object shape of the collision object, the first object shape indicating a spatial area occupied by the target object, and the second object shape indicating a spatial area occupied by the collision object; and
obtaining the candidate reference position based on moving the candidate collision position by the position offset distance along a position offset direction from the candidate collision position toward the candidate object position corresponding to the candidate collision position.
